(19) United States
(12) Patent Application Publication
(10) Pub. No.: US 2025/0355950 A1
(43) Pub. Date: Nov. 20, 2025

(54) Method and System for Data Modeling, Document Classification and Analysis

(71) Applicant: Vigilant AI Inc., Ottawa (CA)

(72) Inventors: Daniel Willis, Smith Falls (CA); Mark Hedley, Dorset (CA); Helge Brueggemann, Vernon (CA); Ronnie Jensen, Kamloops (CA); Shawn Kelly Gardner, Kanata (CA); John Craig, Ottawa (CA); Peter Fong, Stittsville (CA)

(21) Appl. No.: 19/174,060

(22) Filed: Apr. 9, 2025

Related U.S. Application Data
(60) Provisional application No. 63/631,787, filed on Apr. 9, 2024.

(51) Int. Cl. G06F 16/93; G06F 16/28

(52) U.S. Cl. CPC G06F 16/93; G06F 16/285

(57) ABSTRACT

A method is disclosed for analysing a data set to determine a first processes. First messages are provided, the first messages classified into a plurality of different classes with a plurality of different likelihoods, a single first message classified into different classes based on different criteria. From the first messages a first subset of the first messages is retrieved based on a combination of one or more classifications, a likelihood of the one or more classifications, and another classification for messages within the first subset of the first messages. The likelihood of the classifications has more than two (2) potential values.

### FIELD OF THE INVENTION

The invention relates to data analysis and more particularly to automated document classifications through fuzzy logic.

### BACKGROUND

Traditional business process audits are based on the premise that the GL (general ledger) is the primary source of truth. In an enterprise this is in itself not problematic. But it is somewhat limiting. When it comes to a corporation, the ledger and its supporting financial systems represents approximately 20% of the overall data. This leaves roughly 80% of the data untapped as a source of truth.

Consider the following situation, the GL is being updated at month-end. In the massive rush of month-end, a few errors occur, some of the input data is misinterpreted and some of the input data gets corrupted in the GL and a line or two from the table get deleted with no one aware of the issues. Six months later, an audit is in process. The corrupted GL is deemed the primary source of truth and the audit proceeds. The auditors may or may not discover the errors introduced earlier on. Or they may actually go off in search of the corroborating documents and waste significant time and cost looking for evidence that is just not there. Similarly, it might be problematic or even catastrophic if the missing entries are not detected.

It would be advantageous to provide an improved view of facts, events, and supporting documentation, gaining stronger insights into the financial situation of the organization.

### SUMMARY OF EMBODIMENTS

In accordance with embodiments there is provided a method comprising: providing a plurality of first messages; providing a data driven process model; allocating data relating to data fields within the plurality of first messages into a data driven process modeled by the data driven process model; determining some data of the plurality of first messages that is misaligned with a ground truth for the data driven process; determining a likelihood that the some data is part of one or more first messages that though misaligned are a source of information for said ground truth; and when the likelihood is above a first threshold but less than 100%, selecting the one or more first messages as the source of the information for said ground truth.

In some embodiments when the likelihood is above a second threshold but less than the first threshold, selecting the one or more first messages as a potential source of the information for said ground truth.

In some embodiments the one or more first messages are presented for disambiguation by a user as one of a source of the information for said ground truth and other than a source of the information.

In some embodiments a plurality of messages of the first messages and that are misaligned are presented as a potential source of the information for said ground truth and allowing a user to select one or more of the first messages presented as the source of the information for said ground truth.

Some embodiments comprise for the some data, determining second messages from the first messages that are associated with a same data driven process instance and, in dependence upon the second messages, the data driven process instance and data within the ground truth, determining a likelihood that the some data is a relevant source of information for said ground truth.

Some embodiments comprise for the some data, determining second messages from the first messages that are associated with a same data driven process instance and, in dependence upon the second messages, the data driven process instance and data within the ground truth, determining a likelihood that the second messages are a relevant source of information for said ground truth.

Some embodiments comprise for the some data, determining second messages from the first messages that are associated with a same data driven process instance and, in dependence upon the second messages, the data driven process instance and data within the ground truth, determining a likelihood that one or more of the second messages are a relevant source of information for said ground truth.

Some embodiments comprise for the some data, determining second messages from the first messages that are associated with a same data driven process instance and, in dependence upon the second messages, the data driven process instance and data within the ground truth, determining a first likelihood for each of the some data that is a relevant source of information for said ground truth and determining a second likelihood for at least one of the second messages that the second messages are a relevant source of information for said ground truth.

Some embodiments comprise based on all determined likelihoods, filtering data that has a likelihood below a second threshold, lower than the first threshold and filtering data that is unlikely to be a source of information relating to a ground truth in view of all the determined likelihoods and their associated data.

In accordance with some embodiments there is provided a method comprising: providing first data from a variety of data sources; providing ledger data; providing a data driven process model; classifying the first data in accordance with the data driven process model to connect fields within the first data with entries in the ledger data; when the first data aligns with the ledger data, associating the first data with the ledger data; when the first data does not align with the ledger data, determining a likelihood that the first data aligns with the ledger data, the likelihood a value between 0 and 100 percent; when the likelihood is above a predetermined threshold, associating the first data with the ledger data and flagging the association; and when the likelihood is above a second predetermined threshold less than the first predetermined threshold and below the first predetermined threshold, one of providing the first data for verification and associating the first data with the ledger data and flagging the first data for disambiguation.

Some embodiments comprise providing the first data to a user for verification.

Some embodiments comprise associating the first data with the ledger data and flagging the first data for disambiguation.

In some embodiments classifying the first data in accordance with the data driven model to connect fields within the first data with entries in the ledger data comprises classifying the first data based on content of the first data and content of data associated with the first data.

In some embodiments determining a likelihood comprises determining a likelihood based on content of the first data, ledger data, and content of other of the first data associated with the first data.

In some embodiments providing a data driven process model comprises: extracting from the first data a plurality of data elements that are associated with a same data driven process instance; determining data within each of the plurality of data elements that correlates with fields of a data driven process model; forming a model of a data driven process including data for the data driven process model, forms for the data driven process model, and a flow of the data driven process model; and providing the model so formed as the data driven process model.

In accordance with some embodiments there is provided a method comprising: providing first data from a variety of data sources; providing ledger data; extracting from the first data a plurality of data elements that are associated with an instance of a same data driven process to provide extracted data; determining data within the extracted data that correlates with fields within a data driven process model; forming a model of a data driven process including data fields for the data driven process model, forms for the data driven process model, and a flow of the data driven process model; and providing the data driven process model so formed for use in analysing data to extract therefrom related data, the related data related by the data driven process model.

Some embodiments comprise extracting from the first data a plurality of data elements that are associated with a second instance of the same data driven process to provide second extracted data; determining data within the second extracted data that correlates with fields within the data driven process model; refining the model of the data driven process based on the second extracted data to provide a refined data driven process model; and providing the refined data driven process model so formed for use in analysing data to extract therefrom related data, the related data related by at least one of the data driven process model and the refined data driven process model.

In accordance with embodiments, there is provided a method comprising: providing first messages; providing a data driven process model; based on the data driven process model, classifying the first messages into at least a class with at least a likelihood, the class selected from a plurality of different classes, a single message of the first messages classified into different classes based on different criteria; and retrieving from the first messages a first subset of the first messages based on a combination of one or more classifications, a likelihood of the one or more classifications, and another classification for messages within the first subset of the first messages.

In some embodiments the one or more classifications are used to mediate likelihoods, one of to render lower likelihoods acceptable and to render lower likelihoods less acceptable.

In some embodiments retrieving is performed by searching the first messages for messages with predetermined classifications and predetermined likelihoods and wherein the first subset comprises the messages with predetermined classifications and predetermined likelihoods.

Some embodiments comprise using a first correlation engine to extract information based on classifications and likelihoods, the information comprising an indication of the messages within the first subset meeting a correlation criterion.

In some embodiments the classification and likelihoods are determined using a second correlation engine.

In accordance with embodiments there is provided a method comprising: using a classification engine, determining a classification of an item and a likelihood that said classification is trusted, the likelihood having at least 3 potential values.

In accordance with embodiments there is provided a method comprising: using a classification engine, determining a template for a message and a likelihood that said template is trusted, the likelihood having at least 3 potential values.

In accordance with embodiments there is provided a method comprising: using a classification engine, determining a plurality of classifications for a data element and, for each classification determining a likelihood that said classification for said data element is trusted, each likelihood having at least 3 potential values.

In accordance with embodiments there is provided a method comprising: providing a classification engine for classifying documents, the documents for being classified into one or more classes; using the classification engine to (a) classify at least one document, and (b) determine a likelihood from three or more likelihoods that the classification is in error, the document classified into a first class with a first likelihood that said classification is in error.

In accordance with embodiments there is provided a method comprising: training a classification engine to perform the following: classify data into at least a classification, and determine for each of the at least a classification a likelihood that said classification is trusted, the likelihood having more than two (2) potential values.

In accordance with embodiments there is provided a method comprising: forming a data schema relating to general ledger data; mapping external data, the external data external to the general ledger, onto the data schema; mapping the external data, onto the general ledger in accordance with the data schema and the value of the external data; resolving data that matches between the external data and the general ledger; and storing an indication of data that failed to resolve.

In some embodiments the indication is a list of potential resolutions to the data that failed to resolve.

In some embodiments the indication is formed with discrete logic.

In some embodiments wherein the indication is formed through use of fuzzy logic.

In some embodiments wherein the indication includes a likelihood relating to at least some of the resolutions.

In accordance with embodiments there is provided a method comprising: storing data for use in a subsequent process, the data indicative of some resolutions and some indications.

In some embodiments mapping comprises: performing table operations on the data schema to result in a new data schema for accommodating the general ledger and the external data.

In some embodiments the external data is analysed using fuzzy logic and assigned to potential resolutions based on an outcome of said analysis, wherein some data is resolved based on a best resolution in view of other available resolutions for same data.

In some embodiments the external data is analysed using fuzzy logic and assigned to potential resolutions based on an outcome of said analysis, wherein some data is resolved based on a best resolution in view of other available resolutions for same data.

Some embodiments comprise presenting to an adjudicator a list of potential resolutions each linked to at least a general ledger entry and to external data, the adjudicator for selecting a resolution form the list of potential resolutions.

In some embodiments the data schema and external data form a single all inclusive schema through application of one of table join, inner join, and outer join.

In some embodiments wherein the data schema and external data form a single all-inclusive schema through analysis of supradata relating to the external data.

In accordance with embodiments there is provided a method comprising: forming a data schema relating to general ledger data; mapping external data, the external data external to the general ledger, onto the data schema; resolving data that matches between the external data and the general ledger; and for data within the general ledger that fails to resolve with external data, storing an indication of data that failed to resolve.

In accordance with embodiments there is provided a method comprising: using a classification engine, determining a template for a message and a likelihood that said template is trusted, the likelihood having at least 3 potential values, wherein the template and the likelihood are incorporated within a classification system when the likelihood is above a first threshold.

In some embodiments when the likelihood is below the first threshold but above a second other threshold flagging the template for review.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 illustrates a simplified methodology of a traditional business process audit according to prior art.

FIGS. 2a-2D, shown is a simplified example of a Data-Driven Business Process model.

FIG. 3 is a simplified example of a Data-Driven Business Process model as used in a traditional audit based on a source ledger. In this traditional audit the source ledger is considered the primary source of truth.

FIG. 4 is a simplified methodology for the classification of documents in a business process from a traditional perspective.

FIG. 5 is a simplified methodology of utilizing fuzzy logic for broader detection and allocation of documents to classifications to facilitate a Data-Driven Business Process Instance for analysis.

FIG. 6 is a simplified diagram of a method whereby errors and omissions in the GL or corresponding subledgers are determined based on a DDBPM-driven alternative source of truth audit similar to that described with reference to FIG. 5.

FIG. 7 is a simplified diagram of a methodology for the detection of subtler errors and omissions based on fuzzy logic application in the context of a DDBPM-driven reverse audit.

FIG. 8 is a simplified flow diagram of a methodology to perform a fuzzy logic-based analysis to gain further insights based on combined sources of truth, the source ledger, and the combined supporting documentation.

FIG. 9a-9c is a simplified diagram of a data-driven business process model as applied to the traditional audit process from FIG. 1 where the primary source of truth remains the source ledger.

FIG. 10 is simplified diagram of a traditional methodology for classification of documents.

FIG. 11 is a simplified diagram of a methodology for classification of documents enhanced by application of fuzzy logic matching to determine document class membership.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Data Element: Data elements are meaningful segments of information logically identifiable but not necessarily constrained by a one-to-one relationship to a traditional file. It is possible for a data element to be an entire file, such as an invoice. However, at times data elements may also be notable sub-segments within a file. For example, an email archive file is a single file. It could be considered a data element. Similarly, that same email archive may contain many data elements in the form of email messages (emails) some of which in turn each may contain additional data elements. Where they are embedded within a file or container, a data element may also be referred to as a data field.

Document class: a collection of one or more documents or files, all of which, share a commonality of traits. In the context of a business process model, these are a collection of one or more data elements. Specifically, the data elements reflect data fields that contain information that can be extracted from the document, providing meaningful information from the document in question and relevant to the business process being modeled.

Data-driven Process Model (DDPM): a means of defining a series of tasks based on the changes in state or transformations, that data goes through at each step. It is a process modelled around a known set of document classes where at each step one or more of these document classes is associated with the process. Specifically, the documents are created, modified, touched, read, altered, consumed, destroyed, or have some other direct or indirect interaction with the task in question.

Modeled Business Process: Is a means of representing activities which are undertaken by an enterprise in a normal course of business operations. It includes a representation of the flow of a process, outlining each step taken in executing the process. A modeled business process includes a representation of the order of these steps, their dependencies, and their interrelationships. It also includes modeling and representation of the data associated with these steps. This includes, data and documents created, consumed, referenced, updated, or destroyed for each step in the process or involved in the process overall. A completely modeled business process identifies and includes representation of the informational segments, data fields, within each of the documents associated with the business flow.

Data-driven Business Process Model (DDBPM): is where the process being modeled is directly associated with a well-known business task or audit flow, e.g., a sales cycle.

Supradata: supradata is a combination of at least some of metadata regarding a data element. In addition to traditional metadata, it includes actions, transformations, and relationship elements that are stored in a time varying fashion such that metadata is appended to previous metadata instead of overwriting same to form a present, historical, and continuously deepening data set. In addition, supradata includes context regarding the data element. The context may give reference to the origins of the data, the purpose of the data, or the contents of the data. Some context also includes actions on, interactions with, associations, and relationships with other data elements within a data set. By example, a PDF contract file may include a link to the email to which it was attached when it was delivered, which in turn contains a link to the email archive from which the email was extracted all within the current or some other external data set.

Table Join: is a common database term referring to the merging of two separate tables, a first table and a second other table, into a resultant third table, which includes information from the two separate tables.

Inner Join: is a common database term referring to a join of two or more tables where all rows are included from the constituent tables when there is at least one common column with which to match and the values in the common column(s) match by some specified criteria. Omitted are rows where the common column values do not have matching values.

Outer Join: is a common database term referring to the merging of two separate tables, a first table and a second other table, into a resultant third table. The two constituent tables must have at least one or more common column(s). In an outer join, all rows are included, even where the common column(s) have values which do not align.

Discrete Logic: a decision-making process wherein there can be only two possible answers, yes or no. It is akin to digital logic upon which most digital computing systems are based, where computation is based on data represented as binary digits (bits) that have a possible value which is either 1 (yes) or 0 (no).

Fuzzy Logic: a decision-making paradigm wherein there may be a multiplicity of possible answers which are acceptable or true between the discrete Yes or No. It is akin to human thought where there may be many possibilities to an answer. Stated another way, it is an approach to variable processing that allows for multiple possible truth values to be processed through the same variable.

Stochastic Process: a non-deterministic process governed by a set of random variables. In a stochastic process analysis, a collection of one or more variables which dictate the state of a data element may be considered and evaluated when determining the state and equivalence of more than one data element.

A financial audit is a mechanism where an organization seeks to validate that it is carrying out business correctly. It evaluates the business processes involved in the day-to-day operations of the organization to ensure they are structured, controlled, and executed correctly in support of the successful achievement of the business and financial goals of the organization. It ensures such operations are carried out within the boundaries established by internal risk management and governance and external law and regulation. It establishes the trustworthiness of the organization's financial information, validating their business processes and verifying the organization's books.

In the world of enterprise finance and financial audit in particular, the general ledger (GL) is considered the primary source of truth for the corporation. This means that any financial audit of the corporation begins with and is based on the GL and its corresponding sub-ledgers. They are considered the fact-based, official financial corporate record. This is a proven and widely accepted contemporary business norm.

Audits, therefore, become predominantly verifications of the GL and its sub-ledgers, in the context of the business processes of the enterprise. Several other factors are also considered such as the risk profile, governance, and regulatory environment. Based on these criteria, supporting documentation and evidence is gathered to determine the veracity of, or issues with, the ledgers under review.

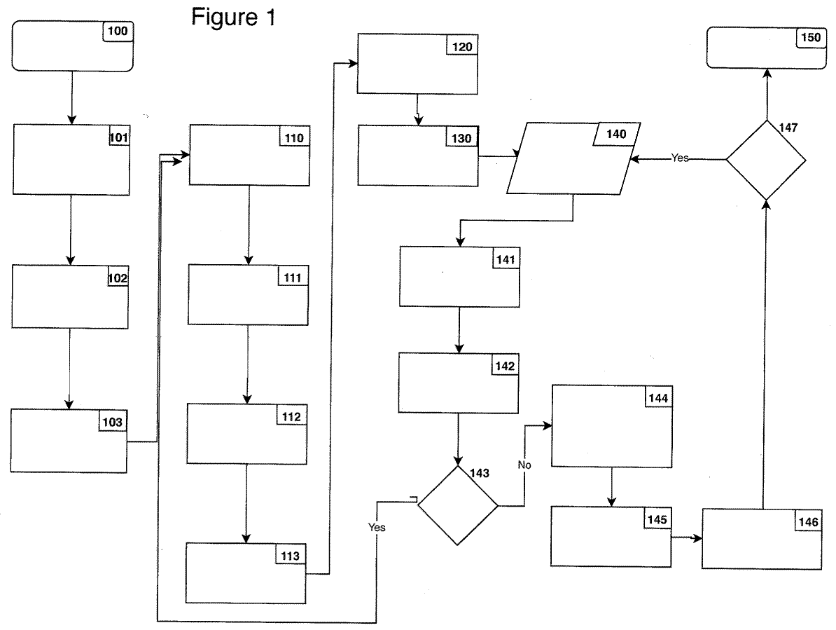

Referring to FIG. 1, what is shown is a simplified methodology of a traditional business process audit. The audit begins at 100. At 101, preparation for the audit occurs. This is followed by a client interview at 102 and then documenting and planning the audit at 103.

Historically, a large part of the effort in such audits, is focused on the data collection, starting at 110. The data collection process begins with estimating the information flow on which the ledger is based at 111. For example, the process might be receive an order, deliver the order, invoice the order and then get paid for the order. Alternatively, the process might include quoting, negotiating, getting quotes from outside support, and then going to contract, delivery, invoicing and payment. Different processes result in different documents being inspected in the audit because different documents exist.

At 112, documents to be audited and documentation to support the documents to be audited are compiled. Often the compilation is a result of the process determined at 111. At 113, external documentation or other more difficult to retrieve documentation is compiled for the audit.

Often, data collection is a large amount of effort and still results in incomplete documentation and is therefore returned to during the processing of data audit numerous times to try to find missing documents. So, an audit test is selected at 120 for determining how or to what end the audit is being performed. Does each transaction in the ledger need an air-tight supporting document? Sometimes, selecting the audit test includes selecting a sampling or section of the ledger that is to be audited at 130 according to a given test. Some aspects of a ledger may be subjected to different tests. This is often the case for smaller discretionary accounts such as petty cash.

Another onerous task of the audit is during the individual audit tests. At 140 each source ledger entry has a working paper created for the entry. A goal is to verify the entry against objective evidence. At 141 financials relating to a ledger entry are retrieved. Finding and reconciling appropriate associated documents is next, as at 142, and is predominantly a manual process performed by the audit team. As shown at 143, associated documents may be found and the process continues to 144 or the process may also entail going back to the client organization at 110 to request and garner additional information. At 144 the document and the ledger values are compared for alignment, to determine consistency between the two. Notes are then made regarding inconsistencies or other noteworthy discoveries at 145. At 146 the working paper including all notes and errors has an entry appended thereto and at 147 the process checks if there are more entries to audit. Once no more entries need auditing, the process ends at 150 with the complete working paper being submitted to the auditor for review.

Such manual processes have limitations and are subject to human error or accidental omission. The volume of information being generated by organizations is in most cases continuously increasing, exacerbating the problem. This makes for an intractable manual data coverage challenge. To address this challenge the current state of the art takes two forms, enforcement, and discovery. In the enforcement model, the key supporting documents are expected to be loaded into a secure repository through the same tools that manage the financial books, statements, and the GL; effectively bundling together the document collection with the business processes. The second form, discovery, is essentially the manual process described above when the first form is incomplete or when errors occur.

It would be advantageous to have the means whereby the business processes being audited, and their supporting documentation can be consolidated in a manner that reflects reality and information completeness, but remains separate from the GL. Thereby providing better evidence to compare with the GL from an audit perspective.

In FIG. 1 is shown the complexity of the audit process, specifically in the face of incomplete data gathering. Returning repeatedly to step 110 or even steps 102 and 103, is common and results in a very inefficient and time-consuming audit process.

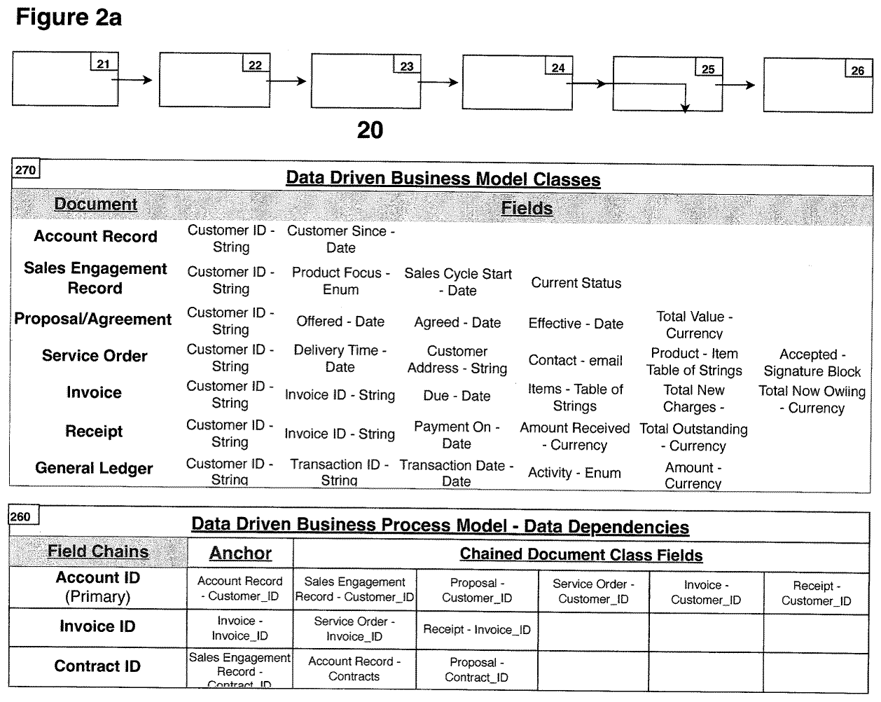

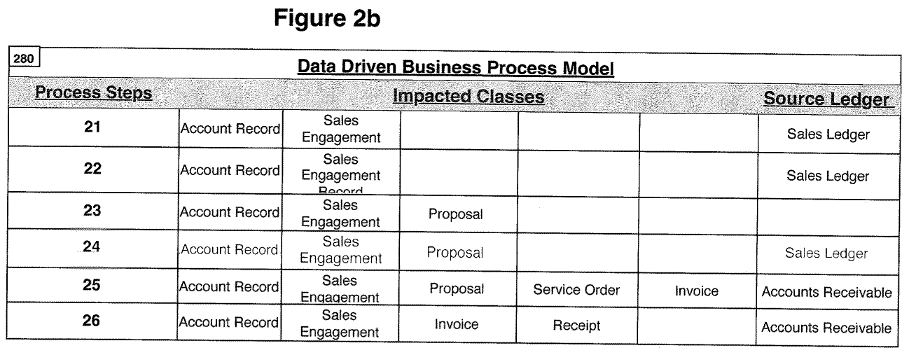

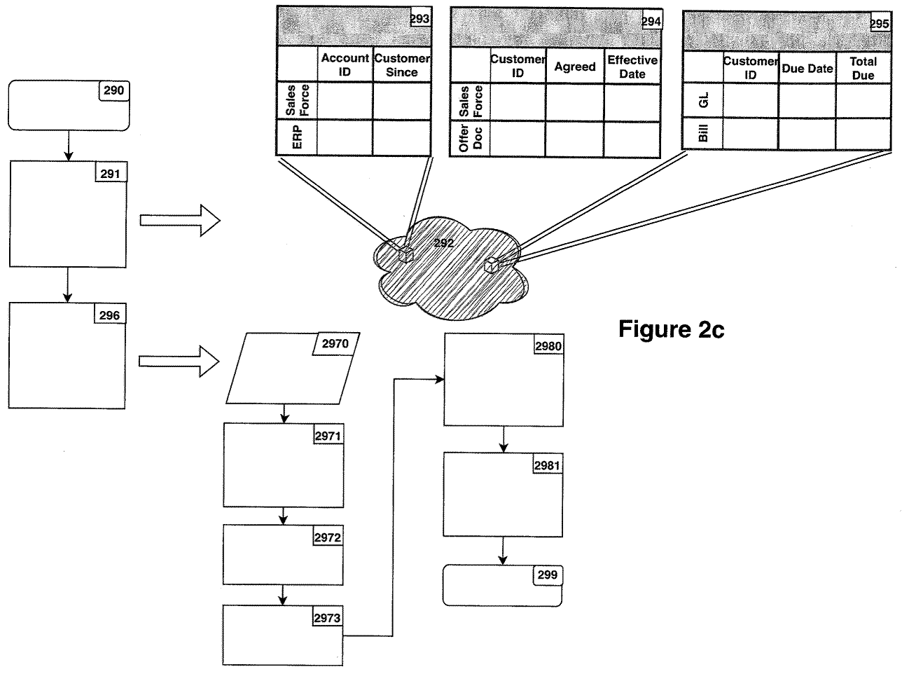

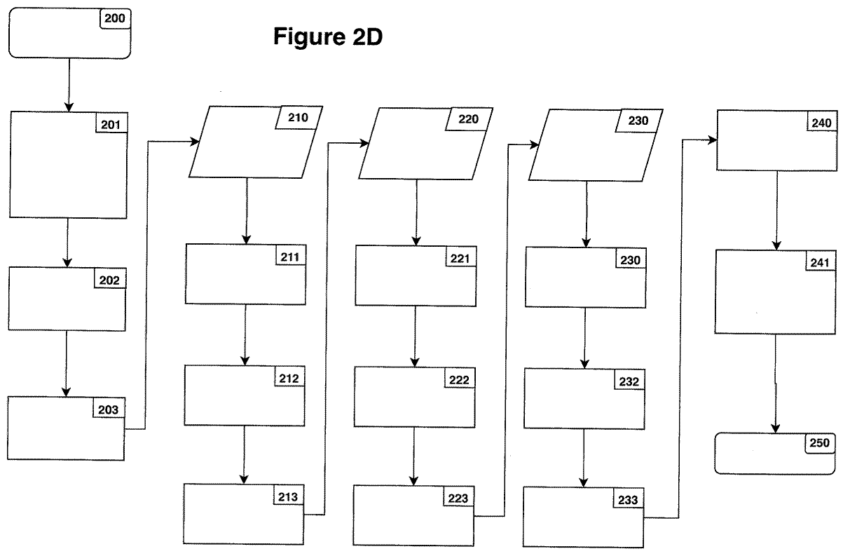

Referring to FIGS. 2a-2c, what is shown is a data-driven business process model as applied to the traditional audit process from FIG. 1. In this application of the model the primary source of truth remains the source ledger. In FIG. 2a, the modeled process is illustrated showing an exemplary sales cycle. In FIG. 2a, Process Steps are defined, at 20, including lead identification and engagement 21, sales and marketing interactions 22, contract negotiations and successful sales 23, product/service delivery 24, billing 25, and payment 26. Document Classes and their required fields are defined, as represented by the table at 270; these include account record 271, sales engagement record 272, proposal/agreement 273, service order 274, Invoice 275, and Receipt 276. There is also a document, general ledger 279, that is being audited. Across the rows of Table 220 are fields such as the customer ID, amounts, dates, status, etc. These fields are different for different documents. In this example, customer ID 2711 is a common field for all the document types.

The table at 270 is also augmented with the field chains that describe the document class interlinkages. Illustrated by the table at 260, for example, the primary field chain for an account record 271 is account ID 261. Customer ID (not shown) often occurs in one form or another in all of the document classes. Invoice ID 265 and Contract ID 263 are also shown. The customer ID is anchored by the Account Record document where the Customer ID is created. A secondary field chain is the Invoice ID field which occurs in both the Invoice and Receipt Document classes. Theoretically it optionally occurs in the Service Order class as well. This chain is anchored by the Invoice document class, as this is where the Invoice ID is created. Other chains and inter-dependencies are possible within the model. Of note, the model is established both to record data and to make data retrieval a manageable task.

FIG. 2b, completes the data-driven business process model by mapping the Document Classes to process steps with which each document class is associated, as shown in the table at 280. This table also maps the process steps to corresponding source ledgers which are subledgers of the General Ledger (GL). The table includes a row for lead generation 281, sales and marketing 282, contract, 283, service delivery 284, billing, 285, and payment 286. In each row are records that relate to the process step, for example lead identification relates to an account record and a sales engagement record. A more fully detailed version of this model would also include the specific fields of relevance for each process step from the document classes and the way in which these fields are related to the process step. For example, in some embodiments, the Invoice ID field is created at the Invoicing step.

FIG. 2c, illustrates how the use of fully contextualized repository-Supradata repository-automates discovery of related documents and encapsulated data elements they contain, as they pertain to an instance of the modeled business process. The methodology begins with definition of the DDBPM, the process model, at 290. To ensure a complete picture of the business process as operated within the organization under audit, the available supporting documentation is loaded into a supra-data repository, at 291. This repository provides a unified source of documents from across silos of the corporation, in a manner which both indexes and contextualizes the documents within it. In this manner, the repository offers a searchable source of the supporting documentation and evidence for the audit.

To build the instance of the DDBPM, beginning at 296, the methodology proceeds by building out individual document classes as defined in the model. For each class 293, 294, and 295, the context and searchability of the supradata repository enables the discovery of all documents that are in this class. They are collected together at 2971. For each document in this resultant class set, the necessary data elements, the fields of interest to the model, are extracted at 2972 and tabulated in the document class instance table at 2973. This continues class-by-class until all associated classes defined in the model are populated.

With all of the class instance tables populated, the integrated model instance is formed. Since the primary source of truth is the source ledger, the ledger fields/columns form a basis of the model instance table. It is the source table. This table is then expanded upon, based on the progression of process steps and the relative data elements from the associated document class instance tables. Merging the document class instance tables proceeds with row matching based on the field chains as defined in FIG. 2a, at 2980 and 2981. Where possible or where there is conflict, priority is given to the primary source of truth, the source table columns.

At 299, the DDBPM instance is fully populated, reflecting the source ledger and all of the appropriate values from the supporting documents and evidence. The insights yielded by the integrated instance offer a much improved and accelerated analytic foundation over traditional audit which collates the data manually. Based on the DDBPM instance, the auditor has all of the corporate information directly at hand and pre-associated with the transactions to which they pertain. This powerful and insightful audit methodology is only enabled by the combination of a supra-data class repository and a Data-driven Business Process Model (DDBPM).

The preceding DDBPM instance is a valuable tool for audits both in verifying correctness and in detecting issues and anomalies in the implemented business practices of the organization under review. However, if there are issues with the data used to build the model, it may not come together as cleanly as outlined in FIG. 2. Therefore, it is necessary to provide a mechanism to construct the DDBPM instance even when presented with flawed data.

Referring to FIG. 2D, what is shown is a methodology for creating data-driven business process models (DDBPM). At its core, the data-driven business process model has basic steps of the audit model. The process commences at 200. Corresponding classes of documents that are associated with the model, in practice, are delineated at 201. The list of document classes are the classes of documents that are involved or associated with the process or any step thereof. Without limitation, being associated with a DDBPM means the document is any of, created, read, opened, closed, updated, written to, deleted, or its presence or status is checked.

At 202 processes are organised into steps. At 203 the source ledger is identified. In most cases each business process is associated with a source ledger; otherwise, a source ledger needs to be identified. This is often the general ledger or one of its subledgers. However, it could technically be any table of transactions or group of ledgers that the process delineates.

The document classes that correspond with the various process steps are also defined in detail, as at 210. A document class has a purpose, a source, and a description set out at 211. A document class has a common relationship, wherein each document in the class shares a set of data elements set out at 212. These elements are fields which are common to all members of the class. Each field has a specific field identifier and has its own semantics described at 213. The semantics define the way in which the data should be interpreted specified. For example, its data type, possibly a range or set of allowable values—or as a corollary a range or set of invalid values, and whether or not the field is required or optional in this particular business process model.

For example, a document class might be proposals. The class purpose is documents that offer a sales business agreement for consideration by a customer. The class shares the common fields of customer ID, effective date, delivery address, signature block, and total cost, where customer ID is an alpha-numeric string, effective date is a calendar date in the format (MM/DD/YYYY), the delivery address is a multiline set of strings that define the brick and mortar address of the customer site to which the product will be delivered, the signature block either shows as someone has signed off or not, and the total cost is a fixed point number with two decimal spaces, representing US dollars. Alternatively, within the class are proposals in different currencies and the total cost also includes a currency indicator. Various documents have other fields, such as items, quantities of items, unit costs, extended costs, and delivery instructions and still be considered as members of the proposals class, so long as they have the fields in question, and they have a purpose of being an offered sales business agreement.

As shown at 220, for each step in the identified business process the document classes associated with the step are defined in the model. In particular, as at 221, either the whole document or the specific fields from the document classes are identified as being associated with the business step. This is also where a type of association is identified for the document class, for example, was it created in this particular process step. In some but not all instances it is more specific to identify the before and/or after-step states of the fields and documents in question at 222. For example, in the proposals class above, a customer agreement to do business only completes an “accepted” process step if there is both an effective date and a signature in the necessary signature block(s). It should be noted that the source ledger is itself a special case of a document class where the fields are in tabular form. An end state of a data field is identified at 223.

At this stage, approaching step 230 in the methodology; the data structures have been identified in the model; the process steps, the document classes associated with the process, and the specific fields within the classes and how they are associated with the process; and its sets are set out defining common field chains. Now in a DDBPM, how all of the data elements fit together is determined at 231. The connectivity or inter-relationship of document classes is identified by field chains.

A field chain is a set of data element fields of document classes that are collectively associated with one another in a known and consistent relationship. The fields in a chain are commonly available in each of the document classes that participate in the chain. One of the document classes within the chain is an anchor and is identified at 232. A reference value by which all the others are arranged/chained based on their relationship in the chain is established based on the anchor. For example, in a sales cycle process, an important field chain is customer ID. Most, if not all, of the document classes involved with the sales cycle, including the source ledger, will have a field defining the customer ID and are defined at 233. In this case the relationship is equals. For all document classes in the process, for a specific step in the process, documents in that class that have the same customer ID as the anchor class customer value, will be associated with the same transaction, driven from the anchoring source ledger. If they all have that customer ID they are all associated with that transaction. Alternatively, a customer has multiple parallel field chains and another anchor, or several values forming a composite anchor are employed. It is possible for a DDBPM to have multiple field chains, defining the changing relationships between document classes from step to step or amongst one another within the same step.

Before 240, the last pieces are in place, including the field chains. All document classes including the special class of the source ledger are optionally included in a field chain. For the process model to have focus, it should be based against a primary source of truth, but this is not always so. A primary source of truth is the document class that is deemed to be “correct” and is presented as the standard by which the rest of the process and surrounding data classes are measured at 241. The identification of proposed fields in this primary source of truth completes the model definition, as at 250.

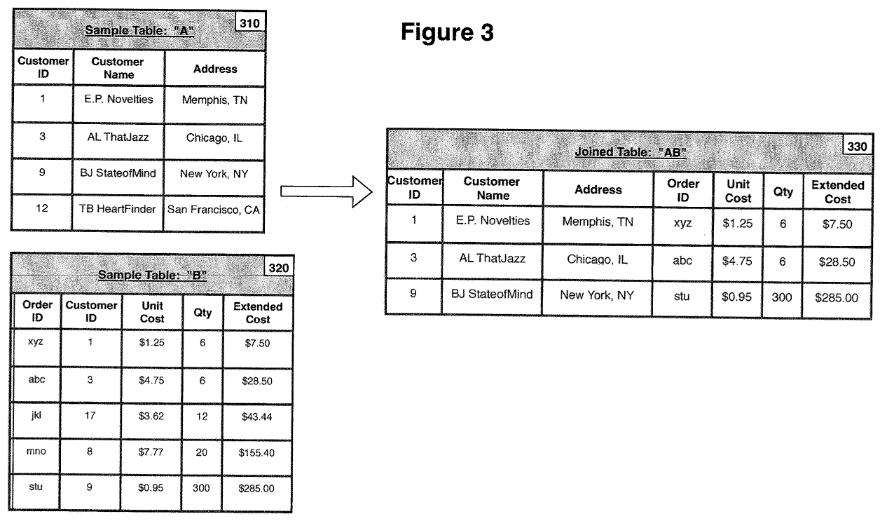

Referring to FIG. 3, what is shown is an illustration of table joining for the combination of structured or semi-structured data in a repository. These techniques are well-known for those skilled-in-the-art. FIG. 3, illustrates an inner join. An inner join reflects, an intersection of the two contributing tables. As with a DDBPM there is a primary field chain; a common field shared between the two tables. With an inner join, the rows of the resultant table reflect the fields from both tables where there is overlap or matching between the values in the shared common field. In simple terms, it is the intersection set of the rows. In the example of FIG. 3, Tables “A”, at 310, and “B”, at 320, have the common field Customer ID. The rows in the resultant joined table, at 330, are only those rows where the Customer ID field matches between tables A and B.

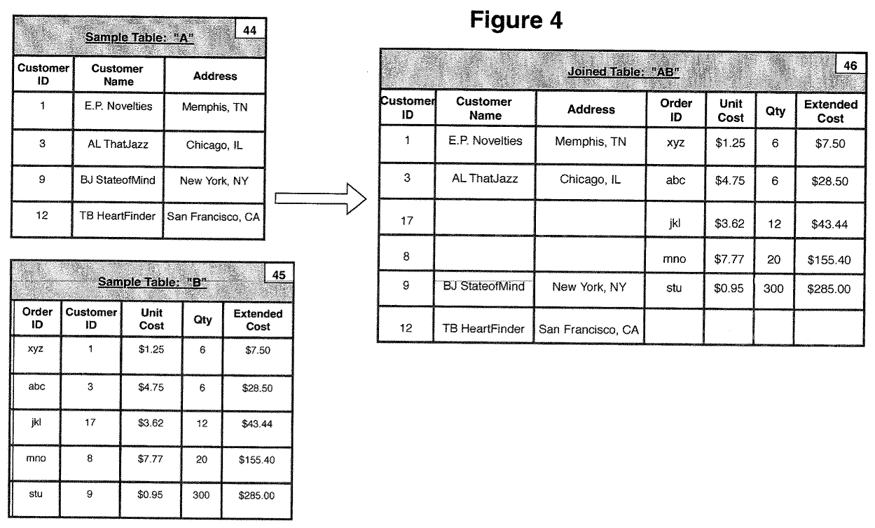

FIG. 4 illustrates an outer join. An outer join reflects, a union of the two contributing tables. As with a DDBPM there is a primary field chain; a common field shared between the two tables. With the outer join, the rows of the resultant table reflect the fields from both tables regardless, whether there is overlap or matching between the values in the shared common field. In the example of FIG. 4, Tables “A”, at 440, and “B”, at 450, have the common field Customer ID. The rows in the resultant joined table, at 460, are both those rows where the Customer ID field matches between tables A and B and those where there is a unique value in either table but not the other.

Applying these techniques when building a DDBPM instance, as previously described, leads to additional and heretofore unknown insights. Each of these outlined join techniques is applied to an imperfect DDBPM instance to aid in completing the model and yielding additional information in the process.

Those skilled in the art may also anticipate a similar methodology where the discovered documents are used as a primary key and transactions with which they are associated are used to identify a corresponding source table as well.

In yet an alternative embodiment, missing data is flagged at a time when it is discovered to be missing. A document without an associated entry is flagged for manual association. An entry without supporting documentation is similarly flagged. By flagging potential errors when they arise, the difficult task of going back in time through mounds of data to find evidence is at least partially eliminated. For example, a missing invoice is requested immediately. An unassigned invoice is assigned immediately thereby reducing orphan invoices that no one can remember where they go. Further, it is often the case that missing documents are known and potentially associated, but without sufficient certainty. Here, fuzzy logic allows a list of potential documents to be “suggested” when flagging an entry without supporting documentation.

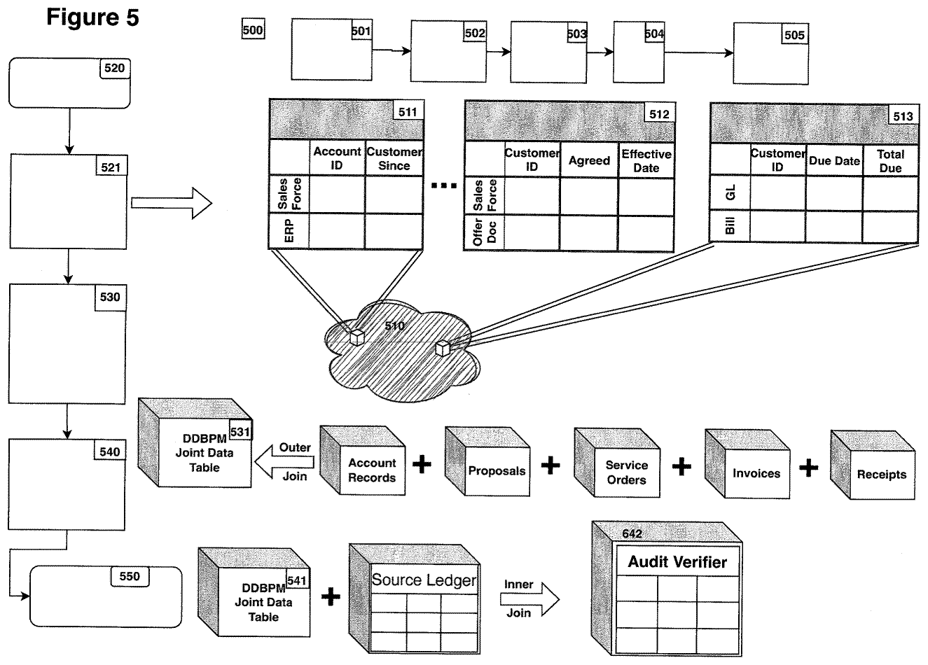

Referring to FIG. 5, what is shown is a method whereby a data-driven business process model (DDBPM) is combined with automated document discovery and data element extraction to produce a semi-structured set of DDBPM data element values. A sample business process of a simplified sales cycle is shown at 500. Process Steps include sales and marketing interactions 501, contract negotiations and successful sales 502, product/service delivery 503, billing 504, and payment 505. Using the defined data-driven business process model, at 520, generating an instance of the DDBPM and tables, and optionally a contextualized supradata repository for the supporting and associated documents 510, an instance of the DDBPM begins to be populated. The involved and associated document classes will each build out into tables reflecting the documents discovered, the repository, and the field values for each of the requisite process steps. These would be tables of document classes, such as seen at 511, 512, and 513. When these semi-structured data element tables are appropriately joined, specifically outer joined as per FIG. 4, with each other as per the model in the DDBPM but not with the source table, the result is an instance of the DDBPM that forms an alternative source of truth, as per 530 and shown at 531. Because the DDBPM Joint table is an outer join, it is the union of the constituent tables, omitting none of the supporting data. This makes it a fully comprehensive source of truth based on the evidence and supporting documents.

At 540, an inner join is performed merging the DDBPM Joint Table with the source ledger being audited. Said another way, the document classes and their values are aligned with the source ledger. As an inner join, based on the ledger as anchor, the resultant table, at 541, shows the supporting data for all transactions from the ledger that are in scope. This makes for a platform, at 550, for the accelerated application of various verification tests and analytics, such as a sample test of details. Such a consolidated platform, particularly one which could be generated through applied machine learning and automation is highly advantageous, making for an accelerated means of audit analysis across a significantly larger data, with fewer errors and manual tasks.

Similarly, this new source of truth generated at 531 is useful to elicit further insights. Consider the results of the inner join performed at 540 if the anchor is the alternative source of truth, the supporting data instead of the ledger. Now the table at 541 shows only those entries which align to the source data as opposed to the ledger. Therefore, it is useful for auditing to find further issues from the source ledger. Essentially, with the source ledger as the GL or its subledgers, the audit process is reversed and enhanced.

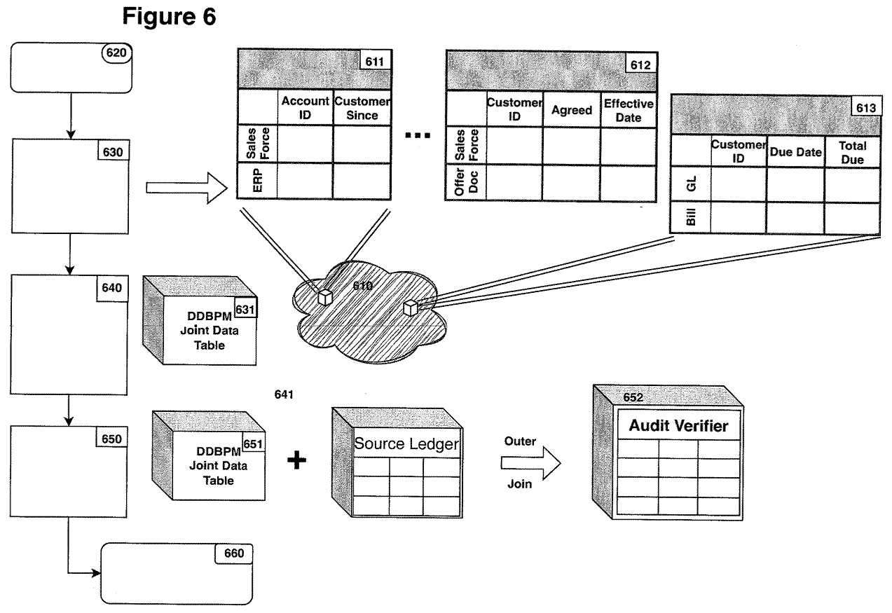

Referring to FIG. 6, what is shown is a method whereby errors and omissions in the GL or corresponding subledgers are determined based on a DDBPM-driven alternative source of truth audit similar to that described with reference to FIG. 5. The difference in the methodology is at step 650. Instead of performing an inner join of the two sources of truth, an outer join is used. Therefore, the table at 652 is the union of the two sources of truth. The table has some rows that are sparse, or with a few missing cells. Such imperfect alignment is insightful, identifying gaps or errors in either the source table/ledger or in the supplied data. Tests of completeness benefit from such a base source of analytic data. In situations where one table or the other is completely empty for the row in question, it is indicative of omissions potentially in the source ledger or of ledger entries where no data is found in support of a transaction.

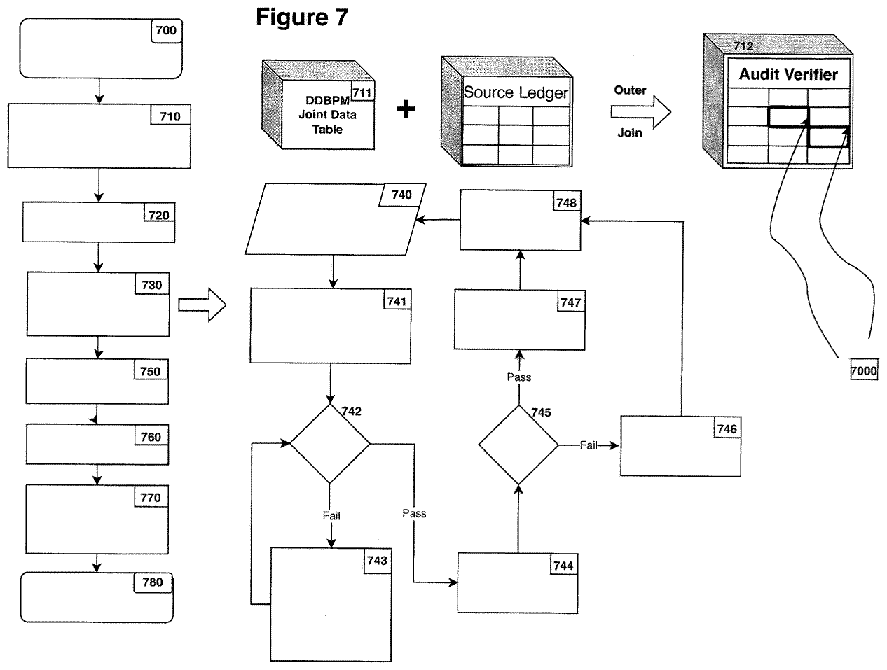

Referring to FIG. 7, what is shown is a simplified methodology for the detection of subtler errors and omissions based on fuzzy logic application in the context of a DDBPM-driven reverse audit. Beginning, at 700, with the alternate source of truth from supporting data of FIG. 5 at 550 with an inner join and/or FIG. 6 at 650, with an outer join with the source table, producing an analytic foundation data table, at 712, upon which a series of tests is performed in the validation, verification, and potential correction of exposed anomalies. Some of the entries in 712 are shown as being flagged as potential anomalies 7000.

At 700 the process is commenced with a populated DDBPM instance. At 710 the data is retrieved. At 720 any exposed anomalies in the foundation table are identified. They show as gaps in the table. These ae sometimes misaligned rows where either the Source Ledger or the DDBPM Joint Data Table, at 711, could not find aligned values in the primary or secondary field chains. At 730, a series of analytic tests are performed to assess whether these misalignments are issues to be highlighted and addressed within the audit. It works on the premise that there may be either missing data or there may be data that is similar but not an exact empirical match to the corresponding values in the field chain.

Starting at 740 each anomaly is examined and tested based on several possible near-miss criteria. The missing data option is explored at 741 by substituting the corresponding known value from the alternate source of truth in the DDBPM model field, supporting data substituted for empty data or source ledger data substituted for missing supporting data as indicated. Then the tests are applied at 742 to see if the results produce an aligned row, i.e., a successful match. When it fails the process moves to 743 as described below. Otherwise, at 744 a corrective value is known and 745 it is tested to ensure it is reasonable. Then when unacceptable, a log failure is made at 746; otherwise it is reported as a potential correction at 747 and the process proceeds to the next anomaly at 748 until all anomalies are tested.

Internally, this process is executable at short intervals, for example monthly, to ensure that by the time a detailed audit is being performed, most data and structures align correctly, making the audit simpler and less costly.

Where data is not missing but not closely aligned, fuzzy logic is applied. Unlike the discrete logic approach where a match must be exact, the misaligned anomalous value is evaluated in a fuzzy value envelope, adjusting, at 743, by an oscillating set of values around the original (+/−). With each oscillation the row is tested for realignment (pass). This continues until the oscillations exceed an acceptable threshold criteria for a match. This results in a set of possible matches, at 750, which is further analyzed at 760 where the data is annotated and 770 where a log is formed, with potentially more than one answer being true. The very definition of fuzzy logic.

This multiplicity of answers is optionally disambiguated, for example by a person. This allows for the selection of the most appropriate true value, based on its divergence from consistency with the rest of the supporting documents. Alternatively, it is disambiguated based on the confidence factors for each of the supporting documents and their extracted data fields. The higher the combined confidence factors of the supporting documents, along the path in question, the more likely it is the correct selection.

For each of these tests, the success or failure of alignment is tracked and logged, and analysis moves on to the next anomaly. Once this exhaustive search has been completed, an analytical log yields insights as to whether issues are due to actual missing data or audit issues; some issues are potential errors that are within an acceptable range. This log, reviewed at 750, aids in analysis or augmentation of the audit itself with identified issues in either the source ledger or the supporting data and documentation.

It is advantageous that this entire process be automated or semi-automated, and the evaluation of output results produced at 760 and when analysis is complete at 780 yield more insights than a completely manual audit. That said, meeting the requirements for a conventional audit with less cost and/or effort remains beneficial. In some embodiments, the resultant tables are further evaluated by applied supervised machine learning. As a direct result of these embodiments, it is possible to achieve an even more comprehensive analysis and additional insights not previously available within the scope and timeframe of a traditional audit.

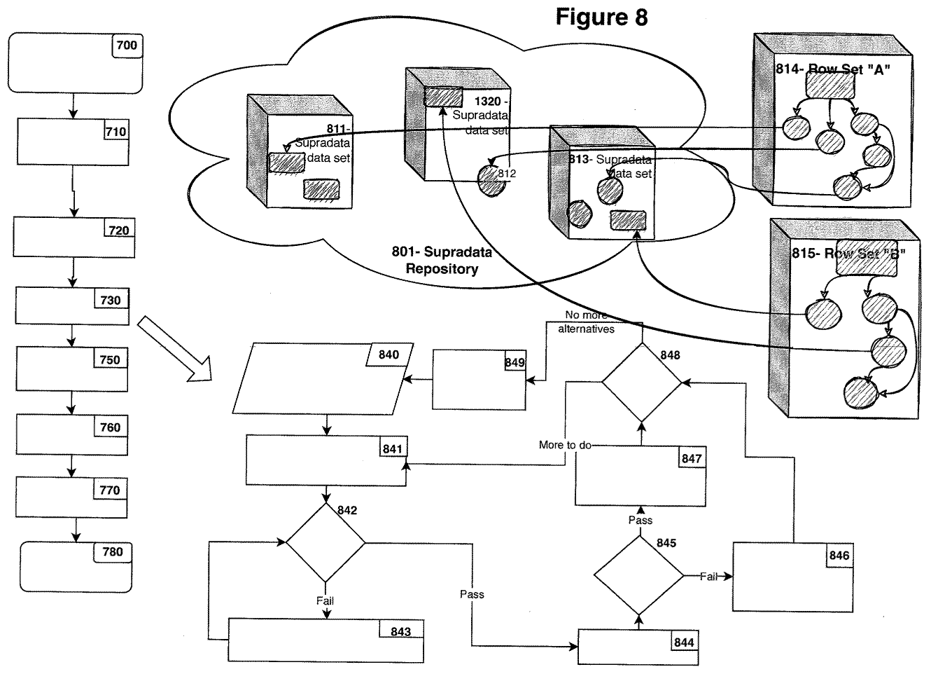

Referring to FIG. 8, what is shown is a simplified flow diagram of a methodology to perform a fuzzy logic-based analysis to gain further insights based on combined sources of truth, the source ledger, and the combined supporting documentation. In this further embodiment, the contextualized repository, also referred to as supradata repository, shown at 801, is used to store the supporting documentation. Supradata repository catalogs and “understands” the alternative sources of data, i.e., the supporting documents and evidentiary data, and their interrelationships 814 and 185. Supradata repositories maintain a deep “understanding” of the context and inter-relationships of the data elements therein. As such for each document in the secondary source of truth, related documents are known.

The methodology in FIG. 8, addresses issues from a modeled business process where there are errors, gaps, or anomalies in either the ledger under audit or the supporting data. It achieves these analytics by extrapolating possible alternative values in resolving the integration and alignment of the joined tables to complete the business model. The combination of the context from the Supradata and the framework and structure of the data-driven business model, provide most of the necessary information. However, where there are issues with either the source ledger or the supporting data exact matches may not occur. This is where fuzzy logic is applied to resolve issues.

Without limitation, in this example shown are two approaches to develop alternatives for fuzzy matching within the model. The two approaches are selection-through-association and alternate paths of data relationships. Both approaches employ a methodology as illustrated in FIG. 8. Beginning with a populated data-driven business process model (DDBPM) instance, at 700, an outer join Is performed to drive alignment between the Joint Data Table, and the Source Ledger associated with this analysis. The outer join between these two tables, performed at 710, produces the fully constituted Data-Driven Business Process Model (DDBPM) instance for the analysis/audit underway. If the table aligns perfectly, with no gaps, no misalignment between rows of either dataset, then the models are well-matched. For this embodiment, we are considering the alternate case, where the resulting table has gaps, holes, and potentially extra or missing rows, collectively called audit misalignments. These audit misalignments are identified and captured at 730.

Each of these misalignments represents either a notable issue for the audit, where the ledger and supporting documentation are not consistent with one another or a potential error in the data sources in the audit, the ledger and supporting documentation. The application of fuzzy logic allows for the exploration and discovery of the latter of these two issues and by extrapolation the first of the issues. For each misalignment, if a value is found to be true, which allows both ledger and supporting documentation to be consistent, then this is a potential correction/alternative solution for consideration as one of multiple true values.

With a possibility for multiple true values, there is preferably a process for disambiguation near the end of the analysis to achieve an acceptable answer. A person could be asked to disambiguate when necessary, but in this analysis a confidence factor will be the guiding factor for disambiguation. For this example, the confidence factor for a value x, is expressed as C(x). By definition, C(x) has a floating-point value ranging between 0 and 1, with 0 indicating no confidence and 1 indicating full confidence. The analytical function that is used to calculate the confidence factor and the acceptance threshold of that confidence factor are specified in advance for each analysis. In this example, for comparing numbers that are incrementally away from an actual true value, the following is usable:
a. X₁ is a first value,
b. X₂ is a second other value,
c. ΔX=|X₂-X₁|
d. C(ΔX)=a formula where as ΔX increases, C(ΔX) decreases

This can be interpreted as the greater the deviation from the original value, the lower the confidence factor, i.e., the less acceptable the value is for the solution. Without limitation, others skilled-in-the-art can develop alternative confidence factor functions to meet the needs of their specific analysis. For example, confidence might be based on a geometric distance of a plurality of values that in an ideal situation would align perfectly.

As previously demonstrated, the supporting data in the DDBPM methodology is considered a legitimate alternate source of truth, both the source ledger and the joint data table are usable as a basis of truth. Based on this, the fuzzy analysis methodology, represented at 840, starts with one or the other. In an exhaustive analysis they are both pursued, each considered in turn. Alternatively, they are each considered in an alternating fashion until all “issues” are resolved.

At 841 alternative values for the misaligned values are selected for analysis using the two fuzzy matching approaches: selection-by-association and alternate paths of data relationships.

In selection-by-association, document classification of a document containing a field that is misaligned is known. By association, other documents are members of this class. For each associated document in the same class, the field value from the associated document is substituted for the misaligned field value and the join from 810 is repeated with the new value as a test, at 842. The result sometimes shows reduced, consistent, or increased misalignment. These degrees of alignment are represented as confidence factors based on the original value of the misalignment as compared to an updated value at 843. An acceptable variation on this methodology is to vary the alternative field value of failing alignments incrementally, tracking the confidence factor as the variance increases. Each time alignments are achieved, the alternate value proceeds at 844 as a possible candidate. At 845 its confidence factor is evaluated to determine acceptability. If the confidence factor is within the pre-established threshold, the candidate is added, along with its confidence factor, to the valid list of alternatives. If the confidence factor, C(ΔX), exceeds the threshold, the alternate value candidate fails and is discarded at 846. If other alternates need testing, then the process continues to 841 for the next alternative. The process continues exhaustively, through 849, until all candidates from a same document classification have been considered.

When a value is below an acceptable threshold, it is one of logged and reported at 847.

Another approach is to use field substitution based on alternative paths of relationships. This is where a particular misaligned field in the document in question, is replaceable by a corrective value that is determined by associated documents outside the documentation class. Consider the simplified example where there is a general ledger entry denoting a transaction with specific customer, represented by Customer_ID, having a transaction date of Feb. 14, 2020, with an amount of $5,000.00, and referencing a specific invoice for the transaction, represented by Invoice_ID. The supporting documentation includes, but is not limited to, the invoice document and the corresponding receipt once payment has been made. In this example the supporting documents both reference the correct Customer_ID, Invoice_ID, and transaction date. From that perspective they would create an aligned business model instance. The supporting documents are referencing the same transaction. However, in the example human error had occurred and a typo had been introduced, on the invoice the transaction amount was captured at $50,000.00. There are several dilemmas in this example:
e. Which is the correct source of truth, the ledger or the supporting documentation?
f. What is the correct value for the amount in the transaction?
g. Is the correct supporting documentation being evaluated for the ledger transaction?

In this example, the two items that are the sources of the error are either the ledger or the invoice. Rather than taking other documents in the documentation classification of invoices, as per the selection-by-association, we can take the documents that are related to the transaction, i.e., have other relationship paths to the two items in question. In some cases, these relationships are direct and straightforward. They are the other supporting documents which would fit the business model instance in the same row as the ledger entry and invoice, for example, the receipt. In some cases, they are not necessarily so directly coupled within the data model. For example, a sales proposal referencing the same customer_ID and the service location, which is in effect for a time period which includes the transaction date, would have relevance but would not be a direct association for the specific transaction. In this case, the supradata relationship mappings yield indirect but completely relevant association. Because the supradata repository has full context and set of relationships for the data elements stored, these related documents are discoverable by exploring the paths of the relationships of the document in question, e.g., the invoice. These related documents are discoverable at 841 and tested appropriately at 842, possibly with variance as applied at 843.

In each of the cases of the related documents, in our embodiment related documents discovered would be the corresponding proposal, service order, in addition to the receipt, which is already part of the model instance. Each is verifiable as associated with the transaction in question by Customer_ID, and transaction date. Each of them has a value for the transaction. By substitution, if the values align, a candidate has been identified. As with selection-by-association, the value alone is not the indicator, the confidence factor is still an automated or semi-automated tool for disambiguation.

In such a case, the confidence factor function considers a depth of relationships between discovered documents, both by the directness of the relationship paths and by a number of aligned and consistent other data fields contained within the relationships. A greater consistency of fields would elicit a higher confidence factor. This confidence factor is additive to the confidence factor generated by any subtle value oscillations from 843. As before, when the test at 842, based on the value discovered through related documents, yields an alignment within an acceptable variance then a success candidate is presented to 844. If the combined confidence factors of the relationships and any oscillatory variance applied are within the acceptable range, as evaluated at 845, then a candidate value and its confidence factor are added to the list of possible acceptable values. This continues exhaustively until all of the possible values have been produced, based on the related evidence, for both the ledger and invoice document transaction amounts.

The number of supporting documents found to be related and the degree of consistency, are indications of which should be considered valid source of truth, the ledger or the document in question. This also yields answers to the questions of is the correct supporting documentation being evaluated correctly and the corrected value that should be applied.

When all the possible values, for both the ledger entry field and the corresponding field within the document under question have been produced, at 750, the analyst has a list of acceptable values and their corresponding confidence factors. From that point the confidence factors are used by the analyst as well as the analyst's experience to distinguish between the values of choice.

At both 860 and 770, the analyst themselves examine the logged results and make the ultimate selection, based on the information discovered within the DDBPM instance.

Upon the completion of this fuzzy logic examination, at 780, the analyst collates their findings. Findings include any annotations and resulting findings that the fuzzy logic approach(es) were utilized.

In some embodiments, this entire process is automated or semi-automated, and the evaluation of the results produced at 760 and 780 yield more insights than a completely manual audit. In some embodiments, the resultant tables are further evaluated by applied supervised machine learning. As a direct result of these embodiments, it is possible to achieve an even more comprehensive analysis and additional insights not previously available within the scope and timeframe of a traditional audit.

In some embodiments, the process is executed at intervals, for example monthly, and results in indications of missing data, placeholders for future execution-notes to be interpreted by future process execution to enhance result speed or quality, or to do lists. Thus, because a fully automated process provides insights, frequent execution allows for a plurality of benefits including data collection closer to when it should have been collected, notes relating to upcoming data—an invoice should be received this week, and data to improve a next execution of the process such that executing the process many times consumes less resources than the number of times multiplied by the resources to execute the process one time.

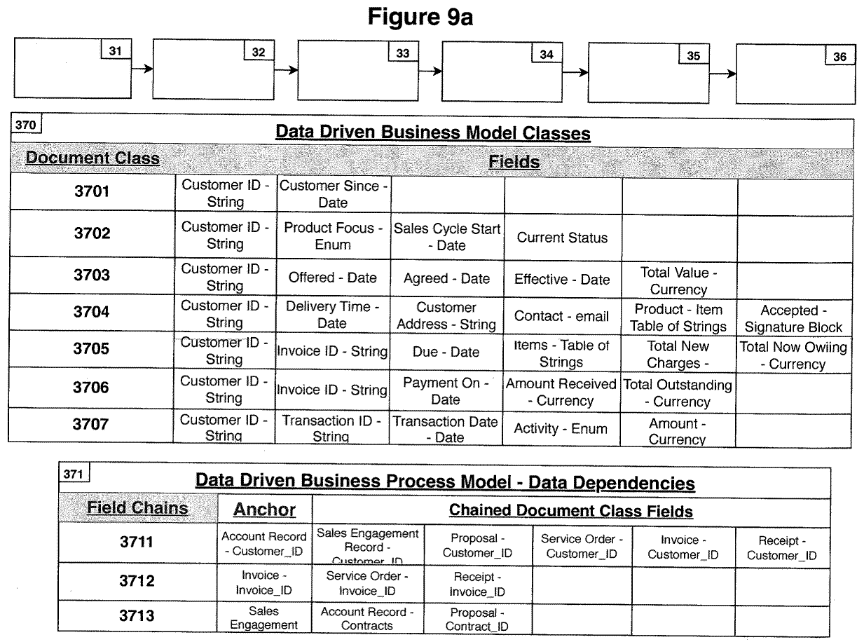

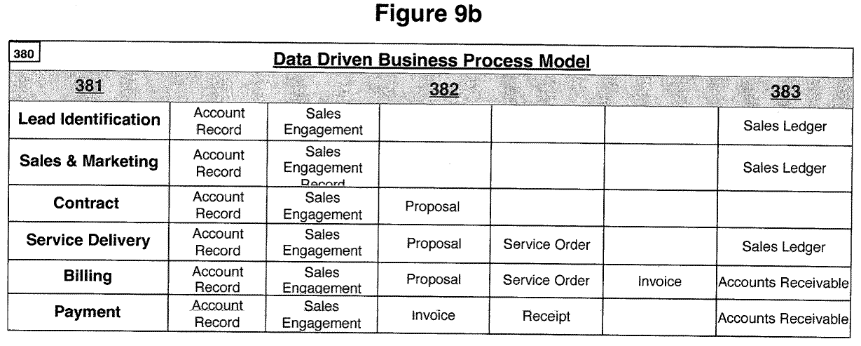

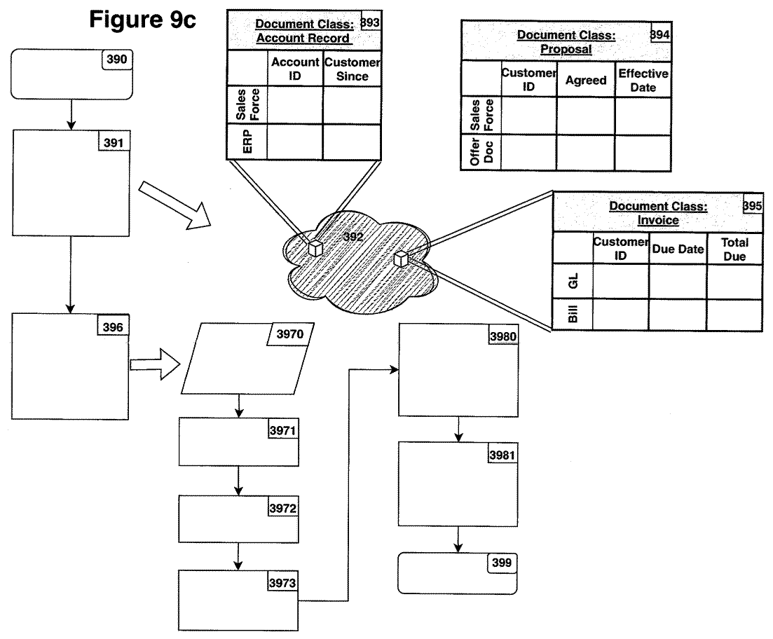

Referring to FIG. 9a-9c, what is shown is a data-driven business process model as applied to the traditional audit process from FIG. 1. In this application of the model the primary source of truth remains the source ledger. In FIG. 9a, a modeled process is illustrated having an exemplary sales cycle. In FIG. 9a, Process Steps are defined, at 30, running from 31 through 36. The primary sales cycle comprises lead identification and engagement 31, sales and marketing interactions 32, contract negotiations, 33 product/service delivery 34, billing 35, and payment 36. Document Classes and their fields are defined, as represented by the table at 370. Of note, the general ledger typically records billing 35 and payment 36, a small subset of the sales cycle data. Here, an account record 3701, a sales engagement record 3702 a proposal record 30703 a service order record 3704 an invoice record 3705, a receipt record 3706, and a general ledger 3707 are shown with their indexable dependencies such as customer ID, invoice ID, transaction ID, etc. Customer ID is associated with each record. Alternatively, another value such as thread ID or sale_ID is associated with linked records for a same transaction process.

Table at 370 is also augmented with field chains that describe document class interlinkage. Illustrated by the table at 371, in the case of this example, the primary field chain is the Customer ID that occurs in one form or another in all of the document classes shown. This is anchored by the Account Record document 3711 wherein the Customer ID is created. A secondary field chain is the Invoice ID field 3712, which occurs in both the Invoice and Receipt Document classes. Optionally, it also occurs in the Service Order class. This chain is anchored by the Invoice Document class, as this is where the Invoice ID is created. Other chains such as the contract class 3713 and inter-dependencies are possible within the model.

FIG. 9b, completes the data-driven business process model by mapping the Document Classes to the process steps wherein each is associated, as shown in the table at 380. Process steps 381 are mapped to corresponding source ledgers, which are subledgers of the General Ledger (GL). Here, the process steps 382 are steps 31 through 36. Alternatively, more or fewer process steps are mapped. For each step, a series of associated records form impacted classes and a target ledger 383 for audit is associated with each step. A more detailed version of this model also includes specific fields of relevance for each process step from the document classes and how these fields are related to a process step. For example, the Invoice ID field is created at the Invoicing step.

FIG. 9c, illustrates how in some embodiments the use of fully contextualized repository—Supradata repository 392—automates discovery of related documents—Account records 393, proposals 394, and Invoices 395—and the encapsulated data elements they contain as they pertain to an instance of the modeled business process. The methodology begins with the definition of the DDBPM, the process model, at 390. To ensure a complete picture of the business process as operated in the organization under audit, available supporting documentation is loaded into a supra-data repository, at 391. This repository provides a unified source of documents from across silos of the corporation, in a manner that both indexes and contextualizes the documents within it. In this manner, the repository offers a searchable source of the supporting documentation and evidence for the audit.

To build the instance of the DDBPM, beginning at 396, the methodology proceeds by building out the individual document classes as defined in the model. For each class 3970, the context and searchability of the supradata repository enables the discovery of all documents that are in this class. They are collected together at 3971. For each document in this resultant class set, data elements, the fields of interest to the model, are extracted at 3972 and tabulated in the document class instance table, at 3973. This continues class-by-class until all associated classes defined in the model have been populated.

With all of the class instance tables populated, the integrated model instance is formed at 3980. In this example, since the primary source of truth is the source ledger, the ledger fields/columns form the basis of the model instance table. It is the source table. This table is then expanded upon, based on the progression of process steps and the relative data elements from associated document class instance tables. Merging the document class instance tables at 3981 proceeds with row matching based on the field chains. Where possible or where there is conflict, priority is given to the primary source of truth, the source table columns.

At 399, the DDBPM instance is fully populated, reflecting the source ledger and the appropriate values from the supporting documents and evidence. Insights yielded by the integrated instance offer a much improved and accelerated analytic foundation over a traditional audit, which collates the data manually. Based on the DDBPM instance, an auditor has all of the corporate information directly at hand and pre-associated with the transactions to which they most likely pertain. This powerful and insightful audit methodology is enabled by a combination of a supra-data class repository and a Data-driven Business Process Model (DDBPM).

The preceding DDBPM instance is a valuable tool for audits both in verifying correctness and in detecting issues and anomalies in the implemented business practices of the organization under review. Given the dependency of this solution on the document classes in defining and populating the model, it is advantageous to have a methodology which enables and enhances automated discovery and identification of documents for each class from a collective data repository or set of repositories.

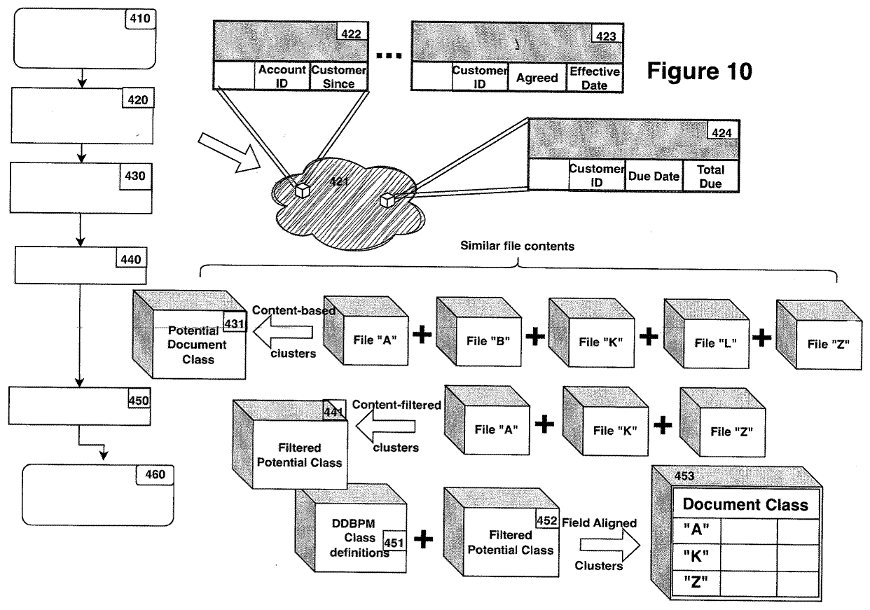

Referring to FIG. 10, shown is simplified diagram of a traditional methodology for classification of documents. The methodology outlines how prior art classification is performed by inefficient manual or brute force mechanisms. The methodology begins with the definition of the business process requiring the classification of supporting documents and the outline of what classes are needed, as at 410. In traditional approaches, at 420, an analyst examines the collective set of the source documents found in the repository, at 421. The data repository is associated with different data sources shown as distributed into groups of records of different types-document class record 422, document class proposal 423 and document class invoice 424. A textual, content-based exercise is carried out, basing predominantly on the text of the contents, both the information fields themselves and the document structure around the content, e.g., field labels such as “Signature:” or “Effective Date:”. The intent is to separate the documents into sets with similar information, e.g., like fields such as Customer_ID or Account_ID. Then at 430, this sorting into clusters of like documents into potential document classes 431, refined based on the details and multiplicity of matching information fields. This is done either by direct document examination and manual comparison of the textual and value-based content or by more formal stochastic analysis around one or more variables to find commonality and congruent or near-congruent values such as a K-Means clustering analysis. The result is one or more clusters of like documents, which could potentially be a data class or a data classification. Each potential data class is then examined to remove outliers and variants that do not have sufficient commonality to be stated and identified within a single class, at 440. The resulting set of clusters, shown as filtered potential classes 441, represents groups of documents which could be considered classes based on the commonality of their data fields.

At 450, the candidate classes are mapped against the requirements of the business process being modeled. Here, DDBPM class definitions 451, filtered potential classes 452 and field aligned clusters in document classes 453 are shown. Each candidate cluster which has data fields that align with the data fields of one of the identified modeling classes is considered a member of a document class. It should be noted that multiple clusters could map to the same aligned document classifications from the business process model and that a single datum may map to multiple classes, depending on the specific implementation. In such situations, the clusters would combine to jointly act as members of the document class. Mutual exclusivity is typically not a requirement. At 460, the output is a data set, 453, that contains the defined document class.

It would be advantageous to have a mechanism other than the manual, brute-force methodology wherein the candidate groupings or clusters are identified and resolved in an automated manner, before, after, or instead of, manual refinement of the candidate document classes. This advantage is enhanced when this methodology is flexible and pliable, based on the inter-relationships and associations of the documents and accounting for subtle variations in the source data. It would be further advantageous if this were applied across the breadth of the full data set in the repository, both subsets and the complete holdings allocated to the project. In this manner, the auditor chooses to work with sample data or exhaustively across the entire data, gaining insights and taking real-world actions based on the true picture defined by the complete set of supporting documents.

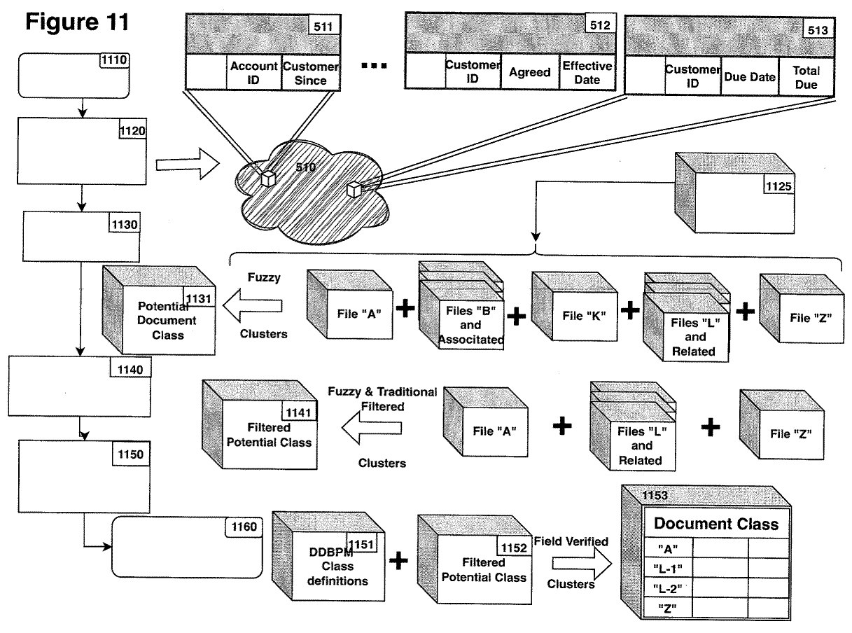

Referring to FIG. 11, shown is a simplified diagram of a methodology for classification of documents enhanced by application of fuzzy logic matching to determine document class membership. The methodology has a similar starting point as the process outlined in FIG. 10 at 410, reflected in this methodology at 1110, where tasks and flow of a data-driven business model are defined. This is where the fuzzy methodology departs from a brute-force approach.

At 1120, the goal is to identify target groupings for document class candidate clusters. This mechanism still includes text-based search and indexing, which is a somewhat discrete process either matching like documents or not. However, it only begins there. It is not limited to this approach. Alternatively, text-based searching is performed using fuzzy logic wherein similar “matches” are included with exact matches. A fuzzy-based solution, by definition, works on the variance of a shared variable. In this embodiment, the variable is commonality. Instead of exact matches on the common data elements and fields, close, similar, related, and associated matches and documents are included as the base set. Just as a human may in considering paint chips, include and match against several different shades of white; eggshell, lace, wintergarden, and high gloss, are all considered. Fuzzy approaches to the preloading discovery of candidate clusters include:
Common content,
Common context,
Common themes,
Common timeframe, and
Common associations.

For example, a single invoice might be issued several times before being accepted, leading to several possible invoices with different field names, different amounts and different dates. Some of the invoices have typos and some do not, for example, the person receiving the quote has their name spelled differently on different versions of the same quote and the quote form has field names that are different from the invoice field names. In any event, the method is attempting to locate the single invoice and quote that match and also match the GL and are the correct invoice and quote while working within the “noise” of human error and small differences. The GL entry may reflect the issuance of payment, which may precede the “actual” invoice date or correct invoice date. Amounts in “Total” field on the quote and “Due” on the invoice may not match in all cases from a given supplier. Forming two classes, one for Total and one for Due only makes sense if the classes are distinct, one from the other. In an ideal process, all invoices are perfectly accurate the first time, all payments reflect the invoices and follow the invoice date, all fields have common names if they are for common classes, there are no typos, everything is in a single language, etc. In practice, this is not always the case.

Common content begins with the textual analysis of the content. In addition to direct matching of the information segments or data elements, matches occur based on either a direct matching of the possible values of a field, even if the field is not labeled, or similar matches to alternative field labels. For example, consider the data field “Date.” The first document selected as a candidate may have a label, as “Date” and having a value of Mar. 17, 2022. The other next document may not include a label “Date”, it might have a field labelled “Effective” and a value of “Mar. 17, 2022”. In the manual process these do not match based on a textual match. However, in the fuzzy process based on common content they may be considered candidate matches because they have the common content value of the date even though it is in differing (non-text matching) formats. With a context-rich repository that includes tagging, labelling, and indexing, many of these content similarities will be discovered and matched based on the common values for a given tag category. Selective use of tagging, labelling, and indexing leads to candidate loads based on either content by values of fields or even by the labels of fields and their values. Those skilled-in-the-art can develop powerful and useful tag lists, categories, and exclusions for clear grouping as a pre-cursor to the clustering. For example, in a garment sales process, grouping around the common contents of “the” or “a” would be less meaningful than grouping based on tag values of “cotton” or “nylon.” Similarly, in some high-volume transaction businesses, grouping around date might be less valuable than about another category.

Similarly, the grouping around like contexts is optionally a non-discrete means for pre-matching. With a fully contextualized and historical repository that retains not only current status by meta-data but past statuses and associations, for example relying on supradata, such an analysis is facilitated. In such a repository the various contexts surrounding a document are readily available and queriable. The context of the contents of the document was covered hereinabove. The commonality of context in this analysis is with reference to the file/document itself, for example, its name or filetype, its origins, who utilizes or interacts with it, its lifespan, and other elements of file-based context. For example, if several of the documents are all denoted as coming from the service fulfilment department, this is a good indication that they are a possible grouping. Similarly, if multiple documents come from finance and are sent or messaged to customers this is a good pre-grouping for the activity at 1120. Alternatively, context is different and changes depending on external or internal factors; for example in some embodiments, quotes are not maintained once an invoice is present and verified.

In another embodiment of application of fuzzy logic to the pre-grouping phase, methodology 1120, the commonality, which is varied and used as a source of pre-grouping, is a theme of the documents. With a supradata repository as described above, the meta-data defining the theme of the document is available and an excellent indicator for pre-grouping. For example, out of a set of documents those that are contracts are one group, request for proposals another. Or even more specifically, the party responsible for loading the repository has tagged the documents with their themes, such as invoices or receipts, all of which are readily available for the 520—based pre-grouping phase.

Yet another commonality to be varied and used in pre-grouping available in a contextualized repository is commonality of associations. Consider documents that have been loaded into the repository together, at the same time. Or consider documents loaded from the same source, by the same transit pathway, or by the same analyst; each of these are commonalities of association to pre-group. In some embodiments, a fully contextualized nature of the repository also includes linkages between documents and data elements such as being “related to” one another. For example, if the documents came in as an email archive that was de-constructed in the repository, files which were bundled with and then detached from the same email are “related to” either each other or the common email/messaging channel on which they were delivered.

Each of these fuzzy logical approaches to pre-grouping are applied within or by a separate process, at 1125, which queries the repository and other sources of information and context to resolve the pre-groupings of the documents relying on fuzzy logic.

Optionally, applied generative AI techniques are used to allow for these groupings through commonalities in content, context, theme, association and, without limitation other document-based commonalities for pre-grouping.

Continuing with FIG. 11, at 1130, identified pre-groupings are refined into pattern-based clusters as candidate document classes. Using fuzzy techniques based on commonality, individual files or sets of associated and related files are considered in concert with the goal of defining the potential class based on the set of common data elements contained therein. The process at 1125 is again useful in this refinement and is also applicable in the mapping of like-but-not-identical data element fields together, e.g., “Date” and “Effective from” fields. By the end of 1130, the potential document class has been defined, as per 1131, with all associative mappings in place for similar but not identical fields.

At 1140, the refined candidate groupings/clusters of files are defined, then an additional pass is needed, with the help of 1125, to evaluate each of the files/documents in the cluster to ensure that they meet the common data element/field requirements of the forming document class. Non-compliant members are filtered out. At 1141, the candidate document class is constructed.

The remaining activity is the mapping of the candidate class, 1152, to the data-driven business process model, 1151, to ensure that the candidate class is meaningful for the business process. If it fails to map, it is still in fact a document class, by definition. Such unmapped classes are valid but not applicable to the data-driven business process model. Only classes that meet the mapping requirements of 1150 become a working document class at 1153 for presentation at 1160.

Advantageously, this entire process is often capable of being automated, with evaluation of results produced at 1180 and 1163 potentially yielding more insights than a manual audit. Further, the resultant sets of documents (document classes) is further evaluable by applied supervised machine learning.

Numerous other embodiments may be envisaged without departing from the scope of the invention.

What is claimed is:

1. A method comprising:
providing a plurality of first messages;
providing a data driven process model;
allocating data relating to data fields within the plurality of first messages into a data driven process modeled by the data driven process model;
determining some data of the plurality of first messages that is misaligned with a ground truth for the data driven process;
determining a likelihood that the some data is part of one or more first messages that though misaligned are a source of information for said ground truth; and
when the likelihood is above a first threshold but less than 100%, selecting the one or more first messages as the source of the information for said ground truth.

2. A method according to claim 1 comprising:
when the likelihood is above a second threshold but less than the first threshold, selecting the one or more first messages as a potential source of the information for said ground truth.

3. A method according to claim 2 comprising:
presenting the one or more first messages for disambiguation by a user as one of a source of the information for said ground truth and other than a source of the information.

4. A method according to claim 3 comprising:
presenting a plurality of messages of the first messages and that are misaligned as a potential source of the information for said ground truth and allowing a user to select one or more of the first messages presented as the source of the information for said ground truth.

5. A method according to claim 1 comprising:
for the some data, determining second messages from the first messages that are associated with a same data driven process instance and, in dependence upon the second messages, the data driven process instance and data within the ground truth, determining a likelihood that the some data is a relevant source of information for said ground truth.

6. A method according to claim 1 comprising:
for the some data, determining second messages from the first messages that are associated with a same data driven process instance and, in dependence upon the second messages, the data driven process instance and data within the ground truth, determining a likelihood that the second messages are a relevant source of information for said ground truth.

7. A method according to claim 1 comprising:
for the some data, determining second messages from the first messages that are associated with a same data driven process instance and, in dependence upon the second messages, the data driven process instance and data within the ground truth, determining a likelihood that one or more of the second messages are a relevant source of information for said ground truth.

8. A method according to claim 1 comprising:
for the some data, determining second messages from the first messages that are associated with a same data driven process instance and, in dependence upon the second messages, the data driven process instance and data within the ground truth, determining a first likelihood for each of the some data that is a relevant source of information for said ground truth and determining a second likelihood for at least one of the second messages that the second messages are a relevant source of information for said ground truth.

9. A method according to claim 8 comprising:
based on all determined likelihoods, filtering data that has a likelihood below a second threshold, lower than the first threshold and filtering data that is unlikely to be a source of information relating to a ground truth in view of all the determined likelihoods and their associated data.

10. A method comprising:
providing first data from a variety of data sources;
providing ledger data;
providing a data driven process model;
classifying the first data in accordance with the data driven process model to connect fields within the first data with entries in the ledger data;
when the first data aligns with the ledger data, associating the first data with the ledger data;
when the first data does not align with the ledger data, determining a likelihood that the first data aligns with the ledger data, the likelihood a value between 0 and 100 percent;
when the likelihood is above a predetermined threshold, associating the first data with the ledger data and flagging the association; and
when the likelihood is above a second predetermined threshold less than the first predetermined threshold and below the first predetermined threshold, one of providing the first data for verification and associating the first data with the ledger data and flagging the first data for disambiguation.

11. A method according to claim 10 comprising:
providing the first data to a user for verification.

12. A method according to claim 10 comprising:
associating the first data with the ledger data and flagging the first data for disambiguation.

13. A method according to claim 10 wherein classifying the first data in accordance with the data driven model to connect fields within the first data with entries in the ledger data comprises classifying the first data based on content of the first data and content of data associated with the first data.

14. A method according to claim 10 wherein determining a likelihood comprises determining a likelihood based on content of the first data, ledger data, and content of other of the first data associated with the first data.

15. A method according to claim 10 wherein providing a data driven process model comprises:
extracting from the first data a plurality of data elements that are associated with a same data driven process instance;
determining data within each of the plurality of data elements that correlates with fields of a data driven process model;
forming a model of a data driven process including data for the data driven process model, forms for the data driven process model, and a flow of the data driven process model; and
providing the model so formed as the data driven process model.

16. A method comprising:
providing first data from a variety of data sources;
providing ledger data;
extracting from the first data a plurality of data elements that are associated with an instance of a same data driven process to provide extracted data;
determining data within the extracted data that correlates with fields within a data driven process model;
forming a model of a data driven process including data fields for the data driven process model, forms for the data driven process model, and a flow of the data driven process model; and
providing the data driven process model so formed for use in analysing data to extract therefrom related data, the related data related by the data driven process model.

17. A method according to claim 16 comprising:
extracting from the first data a plurality of data elements that are associated with a second instance of the same data driven process to provide second extracted data;
determining data within the second extracted data that correlates with fields within the data driven process model;
refining the model of the data driven process based on the second extracted data to provide a refined data driven process model; and
providing the refined data driven process model so formed for use in analysing data to extract therefrom related data, the related data related by at least one of the data driven process model and the refined data driven process model.
